(19) United States
(12) Patent Application Publication
(10) Pub. No.: US 2008/0301431 A1
(43) Pub. Date: Dec. 4, 2008

(54) TEXT SECURITY METHOD

(76) Inventor: Young Sun HEA, Goyang-si (KR)

Correspondence Address: SCHMEISER, OLSEN & WATTS, 22 CENTURY HILL DRIVE, SUITE 302, LATHAM, NY, 12110, US

(21) Appl. No.: 12/129,847

(22) Filed: May 30, 2008

(30) Foreign Application Priority Data
Jun. 1, 2007 (KR) 10-2007-0053671

(51) Int. Cl. H04L 9/00; H04K 1/00; G06F 12/14

(52) U.S. Cl. 713/150; 380/287; 713/193; 380/255; 713/189

(57) ABSTRACT

Disclosed herein is a text security method. The text security method encrypts both a font and a text constituting a text document in the same manner so that the encrypted text can be correctly viewed only when the encrypted font is provided. The text is encrypted by changing, in a regular manner, positions of intrinsic character images or intrinsic codes of the text within different code areas, and the font is encrypted by changing, in the same regular manner, positions of intrinsic character images or intrinsic codes of glyphs of the font corresponding to the text within different font areas.

### BACKGROUND OF THE INVENTION

1. Field of the Invention

The present invention relates to a text security method. More particularly, the present invention relates to a text security method which encrypts both a font and a text constituting a text document in the same manner so that the encrypted text can be correctly viewed only when the encrypted font is provided.

2. Description of the Related Art

With the development of computing systems and network systems, text documents are easily intercepted by malicious users either from storage media or during transmission. In order to address such problem, various types of text security methods have been developed. However, conventional text security methods are mainly based on user verification and are thus invalid if user information is disclosed. Therefore, a new text security technology is in great demand.

### SUMMARY OF THE INVENTION

The present invention is conceived to solve the problems of the conventional techniques as described above, and it is an aspect of the present invention to provide a text security method which encrypts both a font and a text constituting a text document in the same manner so that the encrypted text can be correctly viewed only when the encrypted font is provided.

It is another aspect of the present invention to provide a text security method in a network information security system, which encrypts both a font and a text constituting a text document in the same manner so that the encrypted text can be correctly viewed only when the encrypted font is provided.

It is a further aspect of the present invention to provide a text security method in a web page security system, which encrypts both a font and a text constituting a web page text document in the same manner so that the encrypted text can be correctly viewed only when the encrypted font is provided.

It is yet another aspect of the present invention to provide a text security method in a messenger security system, which encrypts both a font and a text constituting a messenger text message in the same manner so that the encrypted text can be correctly viewed only when the encrypted font is provided.

It is yet another aspect of the present invention to provide a text security method in an e-mail security system, which encrypts both a font and a text constituting an e-mail text document in the same manner so that the encrypted text can be correctly viewed only when the encrypted font is provided.

It is yet another aspect of the present invention to provide a text security method in a text editor, which encrypts both a font and a text constituting a document in the same manner so that the encrypted text can be correctly viewed only when the encrypted font is provided.

In accordance with an aspect of the present invention, a text security method includes: encrypting an original text of a text document and a font corresponding to the text in the same manner; and restoring the encrypted text to the original text by applying the encrypted text to the encrypted font.

In accordance with another aspect of the present invention, a text security method in a network information security system which includes a main server storing and managing information about a document including a text document input by a user terminal and information about a user, and a security management server performing a user verification operation includes: generating an input conversion key based on user verification information in the security management server in response to a request from the user terminal to store an original text of the text document, followed by encrypting the original text using the input conversion key, requesting that the main server store the encrypted text, and managing the user information and the input conversion key; generating an output conversion key using user information corresponding to the stored text and the user verification information and the input conversion key, in response to a request from the user terminal to transmit the encrypted text stored in the main server, followed by encrypting the text and a font corresponding to the text using the input conversion key and transmitting the encrypted text and the encrypted font to the user terminal; and restoring the encrypted text to the original text by applying the encrypted text to the encrypted font in the user terminal receiving the encrypted text and the encrypted font.

In accordance with a further aspect of the present invention, a text security method in a web page security system of a web server includes: generating an input conversion key in response to a request from a manager terminal or a user terminal for creation, revision or editing of a web page, followed by encrypting an original text of the web page using the input conversion key, creating the web page with the encrypted text, and storing and managing information about the web page and the input conversion key; generating an output conversion key using the input conversion key corresponding to the web page in response to a request from the user terminal for the web page, followed by encrypting a font corresponding to the encrypted text of the web page using the output conversion key, and transmitting the web page and the encrypted font to the user terminal; and restoring the encrypted text of the web page to the original text by applying the encrypted text of the web page to the encrypted font in the user terminal receiving the web page and the encrypted font.

In accordance with yet another aspect of the present invention, a text security method in a messenger security system includes: providing different text conversion keys from a messenger management server to respective messengers of user terminals when the messengers request conversation initiation; providing a converted font from the messenger management server to each of the messengers of the user terminals requesting the conversation initiation, the converted font corresponding to one of the different text conversion keys transmitted to the opposite user terminal; displaying a text, which is input by a user, on a display in the messenger of the user terminal, followed by encrypting the text using the text conversion key from the messenger management server, and transmitting the encrypted text; and decrypting an encrypted text, transmitted from the opposite user terminal, using the converted font from the messenger management server and displaying the decrypted text on the display.

In accordance with yet another aspect of the present invention, a text security method in a messenger security system includes: providing different text conversion keys from a messenger management server to messengers of user terminals when one of the messengers requests conversation initiation; providing different converted fonts corresponding to the text conversion keys from the messenger management server to the messengers of the user terminals; encrypting a text, which is input by a user, in the messenger of the user terminal using the text conversion key from the messenger management server, and transmitting the encrypted text; and decrypting a text, which is input by the user and encrypted, using a converted font corresponding to a text conversion key transmitted to the user and displaying the decrypted text on a display, or decrypting an encrypted text, which is transmitted from the opposite user, using a converted font corresponding to a text conversion key transmitted to the opposite user and displaying the decrypted text on a display.

In accordance with yet another aspect of the present invention, a text security method in an e-mail security system includes: when a mail sender inputs a text using one of standardized fonts in a mail editor and requests to transfer a mail comprising the text, encrypting the text and a font corresponding to the text in the same manner in a mail transmitting server and transmitting the mail comprising the encrypted text and the encrypted font; and decrypting the encrypted text of the mail using the encrypted font in a mail receiving server receiving the mail in response to a request from a mail receiver to read the mail, followed by providing the decrypted text to the mail receiver.

In accordance with yet another aspect of the present invention, a text security method in a text editor includes: requesting, by the text editor, to input an input conversion key in response to a request for storing a text document edited in the text editor; converting an original text of the text document using the input conversion key and storing the converted text, if the input conversion key is input; requesting, by the text editor, to input an output conversion key in response to a request for loading the stored text; and converting a normal font corresponding to the output conversion key, followed by restoring the converted text by applying the converted text to the converted font, and outputting the restored text, if the output conversion key is input.

### BRIEF DESCRIPTION OF THE DRAWINGS

The above and other features and advantages of the present invention will become apparent from the following description of exemplary embodiments given in conjunction with the accompanying drawings, in which:

FIG. 1 is a conceptual diagram illustrating font conversion using a text security method according to an exemplary embodiment of the present invention;

FIG. 2 is a conceptual diagram illustrating text conversion using the text security method according to an exemplary embodiment of the present invention;

FIG. 3 is a diagram illustrating text encryption/decryption using the text security method according to an exemplary embodiment of the present invention;

FIG. 4 is a diagram illustrating encryption of a font file using the text security method according to an exemplary embodiment of the present invention;

FIG. 5 is a diagram illustrating encryption of a text file using the text security method according to an exemplary embodiment of the present invention;

FIG. 6 is a diagram illustrating texts before and after application of the text security method according to an exemplary embodiment of the present invention;

FIG. 7 is a block diagram illustrating a network information security system employing the text security method according to an exemplary embodiment of the present invention;

FIG. 8 is a block diagram illustrating a web page security system employing the text security method according to an exemplary embodiment of the present invention;

FIG. 9 is a block diagram illustrating a messenger security system employing the text security method according to an exemplary embodiment of the present invention;

FIG. 10 is a block diagram illustrating an e-mail security system employing the text security method according to an exemplary embodiment of the present invention; and

FIG. 11 is a block diagram illustrating a text editor employing the text security method according to an exemplary embodiment of the present invention.

### DETAILED DESCRIPTION OF THE INVENTION

Exemplary embodiments of the present invention are described in detail with reference to the accompanying drawings hereinafter.

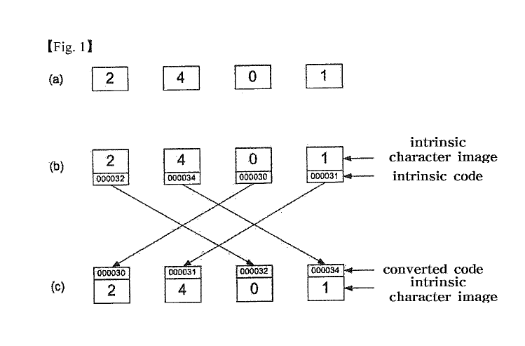

FIG. 1 is a conceptual diagram illustrating font conversion using a text security method according to an exemplary embodiment of the present invention.

In FIG. 1, (a) shows an intrinsic character text, (b) shows the intrinsic character text which is represented as an intrinsic code and an intrinsic character image, and (c) shows a glyph in which a code value of the text is converted.

The intrinsic character text “2401” consists of intrinsic character images “2”, “4”, “0” and “1”, and intrinsic codes “000032”, “000034”, “000030” and “000031”, respectively, for the intrinsic character images “2”, “4”, “0” and “1”. Here, the term glyph represents an image of a character in a font.

As such, in a computing system, a document is displayed in a predetermined font on a display on the basis of intrinsic characters and intrinsic codes assigned to the intrinsic characters. For example, if “2401” is input, “2401” is displayed in a normal glyph as shown in FIG. 1 (b).

However, if an intrinsic character image or an intrinsic code of a glyph is converted to a different one in a different font area, the input “2401” may be represented on a display differently from the input “2401”. For example, if an intrinsic code corresponding to a glyph “2” is changed to “000030” with its intrinsic character image unchanged, an intrinsic code corresponding to a glyph “4” is changed to “000031” with its intrinsic character image unchanged, an intrinsic code corresponding to a glyph “0” is changed to “000032” with its intrinsic character image unchanged, and an intrinsic code corresponding to a glyph “1” is changed to “000034” with its intrinsic character image unchanged, the input “2401” is changed to “0124” on the display as shown in FIG. 1 (c).

As such, the text security method of the present invention is performed by changing positions of intrinsic character images or intrinsic codes of glyphs in different font areas. Accordingly, it is not possible to correctly view a text if it is not known how the positions of the intrinsic character images or intrinsic codes are changed.

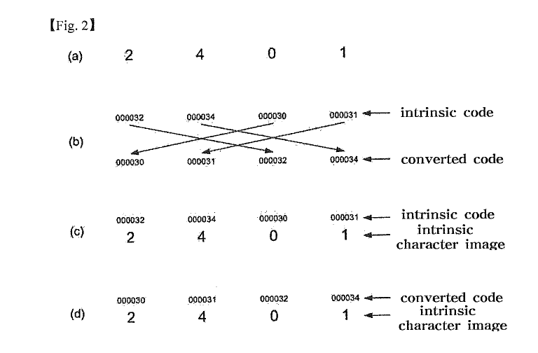

FIG. 2 is a conceptual diagram illustrating text conversion using the text security method according to an exemplary embodiment of the present invention.

FIG. 2 (a) shows the intrinsic character text “2401”, and (b) shows intrinsic codes interchanged in different code areas with respect to the intrinsic character text “2401”.

FIG. 2 (c) shows the text “2401”, which is displayed on a display upon inputting “2401” in a normal condition, and its corresponding intrinsic codes.

FIG. 2 (d) shows the text “0124,” which is displayed on a display upon inputting “2401,” and intrinsic codes corresponding to the text when the converted codes as shown in FIG. 2 (b) are used.

As such, the text security method according to the embodiment of the present invention is performed by changing positions of intrinsic character images or intrinsic codes of a text in different code areas. Accordingly, it is not possible to correctly view the text if it is not known how the positions of the intrinsic character images or intrinsic codes are changed.

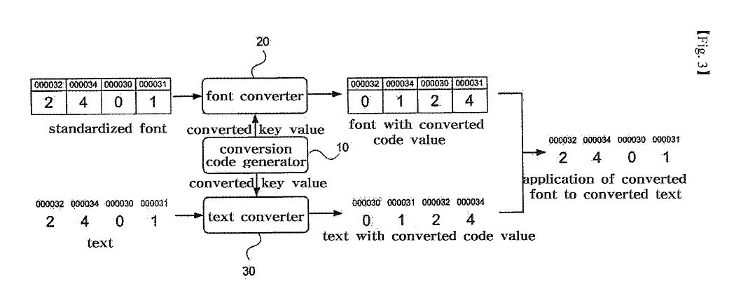

FIG. 3 is a diagram illustrating text encryption/decryption using the text security method according to an exemplary embodiment of the present invention.

A conversion code generator 10 generates a conversion code and transmits the conversion code to a font converter 20 and a text converter 30. The font converter 20 converts an intrinsic code and an intrinsic character image of a standardized font to generate a font with a converted code value according to a conversion code from the conversion code generator 10. The text converter 30 converts an intrinsic code and an intrinsic character image of a text to generate a text with a converted code value according to the conversion code from the conversion code generator 10.

The text converter 30 and the font converter 20 encrypt the text and the font using the conversion code from the conversion code generator 10.

The text converted by the text converter 30 cannot be correctly recognized in a normal font environment, i.e., in a standardized font environment. That is, as shown in FIG. 3, after the text “2401” is converted by the text converter 30, the text “2401” is recognized as “0124” in the normal font environment.

Additionally, the font converted by the font converter 20 cannot be correctly recognized in a normal font environment. That is, as shown in FIG. 3, after the font “2401” is converted by the font converter 20, the font “2401” is recognized as “0124” in the normal font environment.

Accordingly, the code-converted text, i.e., the encrypted text, can be decrypted to a normal text when using the code-converted font, i.e., the encrypted font. That is, as shown in FIG. 3, the code-converted text can be restored to the original text when using the code-converted font.

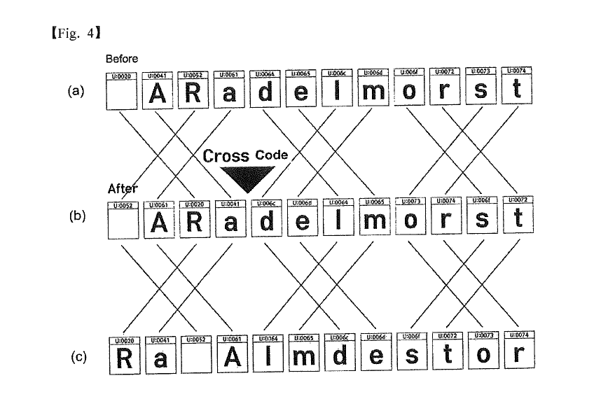

FIG. 4 is a diagram illustrating encryption of a font file using the text security method according to an exemplary embodiment of the present invention.

FIG. 4 (a) shows a font file corresponding to “All roads lead to Rome”. FIG. 4 (b) shows a font file in which positions of intrinsic codes of glyphs are changed in different font areas, for example, using a cross code. FIG. 4 (c) shows a cross code-converted font file corresponding to “All roads lead to Rome”, which are aligned in the code order.

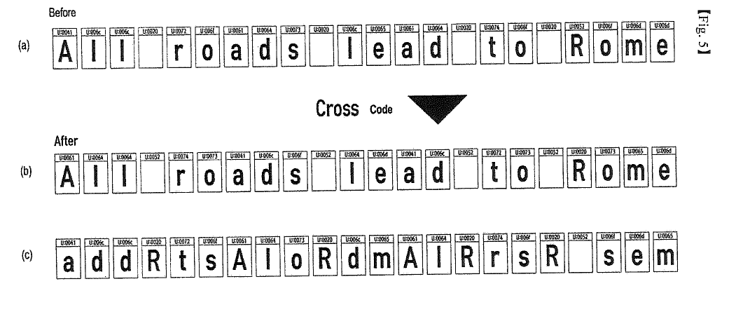

FIG. 5 is a diagram illustrating encryption of a text file using the text security method according to an exemplary embodiment of the present invention.

FIG. 5 (a) shows a text file corresponding to “All roads lead to Rome”. FIG. 5 (b) shows a text file in which positions of intrinsic codes of glyphs are changed using the cross code as shown in FIG. 4 (b). FIG. 5 (c) shows a cross code-converted text file which is aligned in the code order corresponding to “All roads lead to Rome”. That is, as shown in FIG. 5 (c), “All roads lead to Rome” is cross code-converted to “addRtsAloRdmAlRrsR sem”.

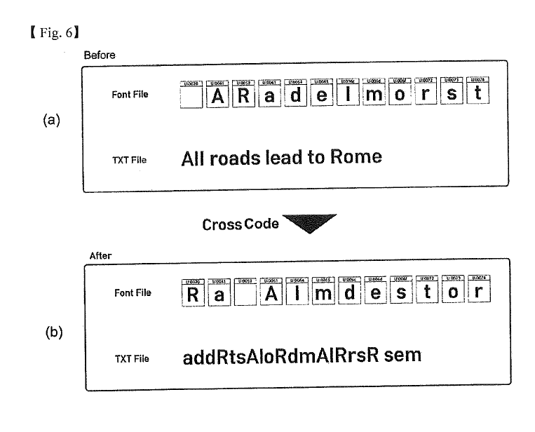

FIG. 6 is a diagram illustrating texts before and after application of the text security method according to an exemplary embodiment of the present invention.

FIG. 6 (a) shows a font file and a text file corresponding to “All roads lead to Rome” prior to applying a cross code thereto. FIG. 6 (b) shows a font file and a text file corresponding to “All roads lead to Rome” after applying the cross code thereto as shown in FIGS. 4 and 5.

Accordingly, if the font file prior to applying the cross code of FIG. 6 (a) is applied to the text file prior to applying the cross code, “All roads lead to Rome” is displayed. Similarly, if the font file after applying the cross code of FIG. 6 (a) is applied to the text file after applying the cross code, “All roads lead to Rome” is displayed.

As such, the text security method according to the present invention encrypts both a font and a text constituting a text document in the same manner so that the encrypted text can be correctly viewed only when the encrypted font is provided.

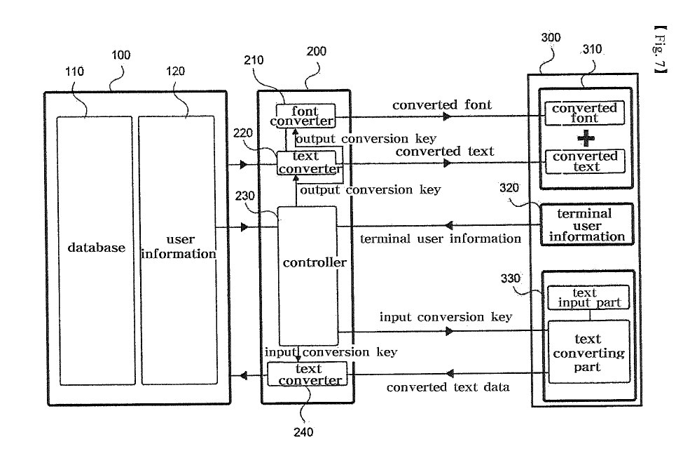

FIG. 7 is a block diagram illustrating a network information security system employing the text security method according to an exemplary embodiment of the present invention.

The network information security system includes a main server 100, a security management server 200, and a user terminal 300.

The main server 100 includes a database 110 and a user information management unit 120. The database 110 stores text documents which are input from the user terminal 300. The user information management unit 120 manages user information, manager information and terminal information, such as hardware information. The user information is used for user verification, and the manager information is used for manager verification.

The security management server 200 includes a font converter 210, a first text converter 220, a controller 230, and a second text converter 240.

The controller 230 generates a conversion key for encryption and provides the conversion key to the font converter 210, the first and second text converters 220 and 240, and a text converter of the user terminal or manager terminal 300. The controller 230 is responsible for control of the security management server 200. The controller 230 performs user verification with reference to user information from the user information management unit 120 of the main server 100 when receiving the user information or manager information and hardware information from the user terminal, generates a conversion key for each user and manages the conversion key.

In response to a request from the user terminal 300 to output a text stored in the database 110 of the main server 100, the first text converter 220 converts the text, which is input from the main server 100, according to an output conversion key from the controller 230 and outputs the converted text to the user terminal 300 using a telecommunication protocol.

Additionally, in response to the request from the user terminal 300, the font converter 210 is operatively associated with the first text converter 220 to convert a font corresponding to the text, which is input from the main server 100, according to the output conversion key from the controller 230 and outputs the converted font to the user terminal 300 using the telecommunication protocol.

Additionally, in response to a request from the user terminal 300 to store the text stored in the database 110 of the main server 100, the second text converter 240 again converts the converted text, which is input from the user terminal 300, according to an input conversion key from the controller 230 and outputs the double-converted text to the main server 100 to be stored in the database 110.

For a font, the term “conversion key” refers to a value used to regularly change the position of an intrinsic character image or an intrinsic code of a glyph in a different font area. For a text, the term “conversion key” refers to a value used to regularly change the position of an intrinsic character image or an intrinsic code of a text in a different code area.

The user terminal 300 includes an output unit 310 and input units 320 and 330.

The output unit 310 receives a converted font and a converted text from the security management server 200 and outputs the original text which is restored by applying the converted text to the conversion font.

The input units 320 and 330 includes a terminal user information input unit 320 that transmits user information of the user terminal 300 to the security management server 200 without conversion of the user information, and a text input unit 330 that includes a text input part and a text converting part. The text input unit 330 transmits to the security management server 200 a converted text which is obtained by converting a text, which is input by a user, in the text converting part using an input conversion key provided from the security management server 200.

If an unauthorized user for the text stored in the main server 100 accesses the network information security system, the unauthorized user cannot correctly view the converted text. In addition, a hacker who hacks into the text stored in the main server 100 cannot correctly view the converted text.

Although both the security management server 200 and the terminal input unit 330 include the text converter in the network information security system shown in FIG. 7, those skilled in the art will appreciate that either or both may have the text convertor.

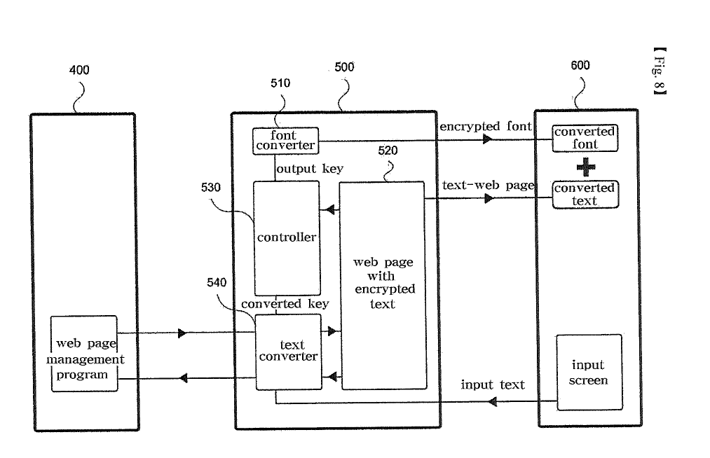

FIG. 8 is a block diagram illustrating a web page security system employing the text security method according to an exemplary embodiment of the present invention.

The web page security system includes a manager terminal 400, a web server 500 and a user terminal 600.

The manager terminal 400, which is equipped with a web page management program, manages the web server 500 under control of a manager who manages and edits web pages.

The web server 500 includes a web page manager 520, a font converter 510, a controller 530, and a text converter 540.

The web page manager 520 stores and manages a web page including an encrypted text. In response to the request from the user terminal 600, the web page manager 520 provides a web page including an encrypted text to the user terminal 600.

In response to a request from the user terminal 600 for a web page, when an output conversion key corresponding to the web page is input from the controller 530, the font converter 510 generates an encrypted font corresponding to an encrypted text of the web page according to the output conversion key from the controller 530, and outputs the encrypted font to the user terminal 600. The term “output conversion key” refers to a value used to regularly change the position of an intrinsic character image or an intrinsic code of each glyph for a font in a different font area.

For a web page including a text which is input from the manager terminal 400 and provided on a web server, the text converter 540 converts the text of the web page into an encrypted text according to an input conversion key, which is input from the controller 530, and outputs the web page written in the encrypted text to the web page manager 520. In addition, for a user web page or a user text, such as a reply, including a text which is input from the user terminal 600 and provided on the web server, the text converter 540 converts the text of the web page or the user text into an encrypted text according to the input conversion key input from the controller 530 and outputs the user web page or the user text written in the encrypted text to the web page manager 520. Accordingly, both the text of the web page created by the manager and the text of the web page or the user text created by the user are encrypted and provided on the web server 500.

The controller 530 generates conversion keys, i.e., an input conversion key and an output conversion key, for encryption and provides the conversion keys to the font converter 510 and the text converter 540. The controller 530 is responsible for control of the web server 500 and manages the conversion keys for all web pages.

In the web server system thus configured, when the user terminal 600 accesses the web server 500 and requests a web page from the web server 500, the web server 500 provides the user terminal 600 with the web page written in an encrypted text and an encrypted font, which is used to decrypt the encrypted text. Accordingly, the user terminal 600 can decrypt the encrypted text of the web page using the encrypted font.

However, the user terminal 600 cannot copy the text of the web page since the text cannot be correctly viewed without a converted font corresponding to the text.

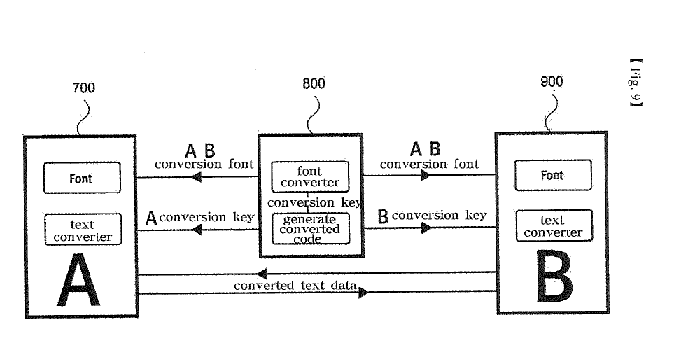

FIG. 9 is a block diagram illustrating a messenger security system employing the text security method according to an exemplary embodiment of the present invention.

The messenger security system provides different text conversion keys A and B to messengers of user terminals 700 and 900 upon requesting conversation initiation. Additionally, the messenger security system provides different conversion fonts A and B corresponding to the text conversion keys A and B to the messengers of the user terminals 700 and 900 upon requesting conversation initiation. In this case, a text using the conversion key A is correctly viewed with the conversion font A, while a text using the conversion key B is correctly viewed with the conversion font B.

The messenger of the user terminal 700 converts a text, which is input by a user, by means of the text converter using the text conversion key A, which is transmitted from the messenger management server 800, and transmits the converted text. The messenger of the user terminal 800 converts a text, which is input by a user, by means of the text converter using the text conversion key B, which is transmitted from the messenger management server 800, and transmits the converted text.

Accordingly, the messenger of the user terminal 700 converts a text, which is input from the messenger of the user terminal 700, by means of the text converter using the conversion key A, and decrypts the converted text using the conversion font A, which is provided from the messenger management server 800, to display and transmit the decrypted text to the messenger of the user terminal 900. Additionally, the messenger of the user terminal 700 displays a text, which is converted by the messenger of the user terminal 900 using the conversion key B, using the conversion font B, which is provided from the messenger management server 800.

On the other hand, the messenger of the user terminal 900 converts a text, which is input from the messenger of the user terminal 900, by means of the text converter using the conversion key B, and decrypts the converted text using the conversion font B, which is provided from the messenger management server 800, to display and transmit the decrypted text to the messenger of the user terminal 700. Additionally, the messenger of the user terminal 900 displays a text, which is converted by the messenger of the user terminal 700 using the conversion key A, using the conversion font A, which is provided from the messenger management server 800.

Therefore, even if a hacker intercepts a messenger text during transmission, it is possible to secure text data and content of the text.

As described above, a messenger of a user terminal converts a text input by a user and decrypts the converted text using a converted font to display the decrypted text. However, the messenger of the user terminal may display a text, which is input by the user, using a normal font, and decrypt a converted text, which is transmitted from the other user, using a converted font to display the decrypted text. In this case, when the conversation starts, the messenger of the user terminal has only to download the converted font from the messenger management server to restore the converted text which is transmitted from the other user.

It is desirable that the messenger of the user terminal delete the text conversion key and the converted font, which are transmitted from the messenger management server 800 to the user terminal upon request of conversation initiation, when the conversation is terminated. The messenger of the user terminal preferably downloads a new text conversion key and a new converted font from the messenger management server 800 when a conversation restarts. In this case, even though the conversation content is stored in the user terminal, the content cannot be correctly viewed without the converted font. Therefore, it is possible to secure the conversation content even after the conversation is terminated.

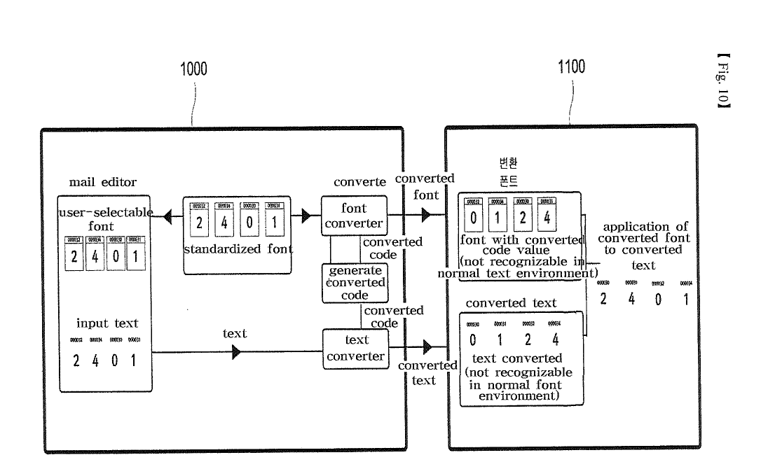

FIG. 10 is a block diagram illustrating an e-mail security system employing the text security method according to an exemplary embodiment of the present invention.

When a user inputs a text using a standard font in a mail editor and requests e-mail transfer, a mail transmitting server 1000 converts or encrypts the text by means of a text converter using a conversion code generated by a conversion code generator. The font selected by the user is converted or encrypted by a font converter using a conversion code generated by the conversion code generator.

The converted text and font are transmitted to a mail receiving server 1100. The converted text is not correctly represented in a normal font environment, and the converted font is not correctly represented in a normal text environment.

When a receiving party reads the e-mail, the mail receiving server 100 provides the receiving party with the text which is decrypted using the converted font.

Accordingly, in the e-mail security system, the receiving party cannot correctly read the e-mail before the receiving party opens the e-mail.

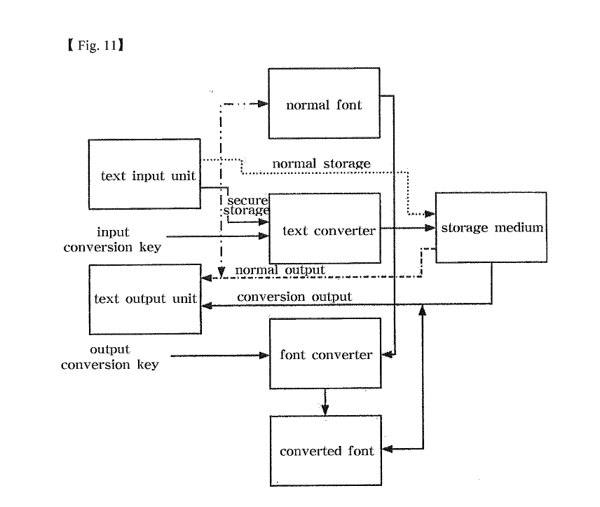

FIG. 11 is a block diagram illustrating a text editor employing the text security method according to an exemplary embodiment of the present invention. Herein, the text editor refers to software which is incorporated in a user terminal, such as a personal computer, to write and edit texts.

A user operates a text editor installed in a user terminal and enters a text using a text input unit. The text is written in a normal font. When it is requested that the text be stored in a normal manner rather than in a secure manner, the text is stored without conversion in a storage medium.

If it is requested that the text be stored in a secure manner, the text editor will request that the user input an input conversion key. If the user inputs the input conversion key, the text will be converted or encrypted by the text converter using the input conversion key, and the encrypted text will be stored in the storage medium. The encrypted text may have no information about the input conversion key.

When the user operates the text editor installed in the terminal and requests that the text output unit load the text stored in the storage medium, the text output unit requests that the user input the output conversion key for the text.

If the user does not input the output conversion key but continues to request that the text be loaded, the text will be read by the text output unit and displayed in a normal font. In this case, if the text is stored in a normal manner, that is, not in a secure manner, the text will be correctly displayed. However, if the text is stored in the secure manner, the text will not be correctly displayed.

If the user inputs the output conversion key and continues to request that the text be loaded, the normal font will be converted or encrypted by the font converter using the output conversion key and the encrypted text will be read by the text output unit and decrypted using the conversion font. If the text is stored in a normal manner rather than in a secure manner, or if the output conversion key is different from the input conversion key, which is input by the user when the text is stored, the text will not be correctly displayed even though the text is stored in a secure manner. However, if the text is stored in the secure manner and the output conversion key is identical to the input conversion key, which is input by the user when the text is stored, the text will be correctly displayed.

Therefore, according to the present embodiment of the invention, the encrypted text cannot be correctly read without the conversion key.

Examples of the user terminal include a wired terminal and a wireless terminal.

As described above, according to the present invention, a font and a text constituting a text document are simultaneously encrypted or converted, and the encrypted font and text are transmitted or stored. Further, a user cannot read the transmitted or stored text document without the encrypted font and cannot generally use the encrypted font. However, the user can view the original or unconverted text document by applying the encrypted font to the encrypted text document. The encrypted text document cannot correctly be viewed in a general font.

The font and the text are encrypted by using all codes, such as character codes, which are used in text documents, Unicode, which is used worldwide, extended codes, and fonts, or collecting all codes in predetermined groups and shifting the codes within the groups.

The font and the text may be encrypted with various kinds of functions according to user environment or security levels.

The present invention may be used without extra programs in any device which can set fonts in existing text documents, when the text documents need to be read.

Since the text and the font may be encrypted in various types of text security methods according to the present invention, it is not possible to read the encrypted text without the encrypted font corresponding to the encrypted text.

Furthermore, according to the present invention, since the entire document is not encrypted but only the text of the document is encrypted, it is not possible to read the text without the encrypted font corresponding to the encrypted text even though the document is disclosed.

For the network security system, the security server may frequently change the input conversion key and the output conversion key so that the text document cannot be viewed in an old encrypted font.

The present invention may be applied in securing text documents which use fonts in TTF, eot and ps formats. Additionally, a glyph may be configured in the text order rather than in a predetermined code. The font may be converted by changing the code of the font or adding the glyph of the font. Only glyphs which are necessary for the present invention may be generated for text security.

Furthermore, the input conversion key and the output conversion key may be changed from time to time. The conversion keys may be set according to users, user groups, documents or document groups.

Furthermore, the user may use his/her private key to edit and store the document and to view the encrypted document in the encrypted font.

As apparent from the above description, according to the present invention, the text security method encrypts both a font and a text constituting a text document in the same manner so that the encrypted text can be correctly viewed only when the encrypted font is provided, thereby reliably securing the text document.

Although the present invention has been described with reference to the embodiments and the accompanying drawings, the embodiments and drawings are given by way of illustration only, and, it will be apparent to those skilled in the art that various modifications and equivalent other embodiments can be made without departing from the scope of the present invention. Therefore, the scope and spirit of the invention should be limited only by the claims set forth herein as follows.

What is claimed is:

1. A text security method comprising:
encrypting an original text of a text document and a font corresponding to the text in the same manner; and
restoring the encrypted text to the original text using the encrypted font.

2. The method according to claim 1, further comprising:
storing the encrypted text and the encrypted font in a storage medium after the encrypting of the original text and the font,
wherein the restoring of the encrypted text comprises restoring the encrypted text stored in the storage medium to the original text using the encrypted font.

3. The method according to claim 1, further comprising:
transmitting the encrypted text and the encrypted font using a telecommunication protocol after the encrypting of the original text and the font,
wherein the restoring of the encrypted text comprises restoring the encrypted text transmitted using the telecommunication protocol to the original text using the encrypted font.

4. The method according to claim 1, wherein the encrypting of the original text and the font comprises encrypting the original text by changing in a regular manner positions of intrinsic character images or intrinsic codes of the text within different code areas, and encrypting the font by changing in the same regular manner positions of intrinsic character images or intrinsic codes of glyphs of the font corresponding to the text within different font areas.

5. The method according to claim 4,
wherein the encrypting of the original text and the font further comprises generating a conversion key; and
wherein the original text is encrypted by changing in a regular manner, using the conversion key, positions of intrinsic character images or intrinsic codes of the text within different code areas, and the font is encrypted by changing in the same regular manner, using the conversion key, positions of intrinsic character images or intrinsic codes of glyphs of the font corresponding to the text within different font areas.

6. A text security method in a network information security system, the network information security system comprising a main server storing and managing information about a document including a text document input by a user terminal and information about a user, and a security management server performing a user verification operation, the method comprising:
generating an input conversion key based on user verification information in the security management server, in response to a request from the user terminal to store an original text of the text document, followed by encrypting the original text using the input conversion key, requesting that the main server store the encrypted text, and managing the user information and the input conversion key;
generating an output conversion key using user information corresponding to the stored text and the user verification information and the input conversion key, in response to a request from the user terminal to transmit the encrypted text stored in the main server, followed by encrypting the text and a font corresponding to the text using the input conversion key and transmitting the encrypted text and the encrypted font to the user terminal; and
restoring the encrypted text to the original text by applying the encrypted text to the encrypted font in the user terminal receiving the encrypted text and the encrypted font.

7. The method according to claim 6,
wherein the original text is encrypted by changing in a regular manner, using the conversion key, positions of intrinsic character images or intrinsic codes of the text within different code areas, and
wherein the font is encrypted by changing in the same regular manner, using the conversion key, positions of intrinsic character images or intrinsic codes of glyphs of the font corresponding to the text within different font areas.

8. The method according to claim 6, wherein the user terminal is a terminal capable of accessing the security management server in a wireless communication manner and/or in a wired communication manner.

9. A text security method in a web page security system of a web server, the method comprising:
generating an input conversion key in response to a request from a manager terminal or a user terminal for creation, revision or editing of a web page, followed by encrypting an original text of the web page using the input conversion key, creating the web page with the encrypted text, and storing and managing information about the web page and the input conversion key;
generating an output conversion key using the input conversion key corresponding to the web page in response to a request from the user terminal for the web page, followed by encrypting a font corresponding to the encrypted text of the web page using the output conversion key, and transmitting the web page and the encrypted font to the user terminal; and
restoring the encrypted text of the web page to the original text by applying the encrypted text of the web page to the encrypted font in the user terminal receiving the web page and the encrypted font.

10. The method according to claim 9,
wherein the original text of the web page is encrypted by changing in a regular manner, using the conversion key, positions of intrinsic character images or intrinsic codes of the text within different code areas, and
wherein the font is encrypted by changing in the same regular manner, using the conversion key, positions of intrinsic character images or intrinsic codes of glyphs of the font corresponding to the text of the web page within different font areas.

11. The method according to claim 9, wherein the user terminal is a terminal accessible to the web server in a wireless communication manner and/or in a wired communication manner.

12. A text security method in a messenger security system, comprising:
providing different text conversion keys from a messenger management server to respective messengers of user terminals when the messengers request conversation initiation;
providing a converted font from the messenger management server to each of the messengers of the user terminals requesting the conversation initiation, the converted font corresponding to one of the different text conversion keys transmitted to the opposite user terminal;
displaying a text, which is input by a user, on a display in the messenger of the user terminal, followed by encrypting the text using the text conversion key from the messenger management server, and transmitting the encrypted text; and
decrypting an encrypted text, transmitted from the opposite user terminal, using the converted font from the messenger management server and displaying the decrypted text on the display.

13. A text security method in a messenger security system, comprising:
providing different text conversion keys from a messenger management server to messengers of user terminals when one of the messengers requests conversation initiation;
providing different converted fonts corresponding to the text conversion keys from the messenger management server to the messengers of the user terminals;
encrypting a text, which is input by a user, in the messenger of the user terminal using the text conversion key from the messenger management server, followed by transmitting the encrypted text; and
decrypting a text, which is input by the user and encrypted, using a converted font corresponding to a text conversion key transmitted to the user and displaying the decrypted text on a display, or decrypting an encrypted text, which is transmitted from the opposite user, using a converted font corresponding to a text conversion key transmitted to the opposite user and displaying the decrypted text on a display.

14. The method according to claim 12,
wherein the text is encrypted by changing in a regular manner, using the conversion key, positions of intrinsic character images or intrinsic codes of the text within different code areas, and
wherein the font is encrypted by changing in the same regular manner, using the conversion key, positions of intrinsic character images or intrinsic codes of glyphs of the font corresponding to the text within different font areas.

15. The method according to claim 12, wherein the user terminal is a terminal capable of accessing the messenger management server in a wireless communication manner and/or in a wired communication manner.

16. The method according to claim 12, wherein the messenger of the user terminal deletes the text conversion key and the converted font transmitted from the messenger management server upon initiating the conversation, when the conversation is terminated.

17. A text security method in an e-mail security system, comprising:
when a mail sender inputs a text using one of standardized fonts in a mail editor and requests to transfer a mail comprising the text, encrypting the text and a font corresponding to the text in the same manner in a mail transmitting server and transmitting the mail comprising the encrypted text and the encrypted font; and
decrypting the encrypted text of the mail using the encrypted font in a mail receiving server receiving the mail in response to a request from a mail receiver to read the mail, followed by providing the decrypted text to the mail receiver.

18. The method according to claim 17,
wherein the text is encrypted by changing, in a regular manner, positions of intrinsic character images or intrinsic codes of the text within different code areas, and
wherein the font is encrypted by changing, in the same regular manner, positions of intrinsic character images or intrinsic codes of glyphs of the font corresponding to the text within different font areas.

19. A text security method in a text editor, comprising:
requesting, by the text editor, to input an input conversion key in response to a request for storing a text document edited in the text editor;
converting an original text of the text document using the input conversion key and storing the converted text, if the input conversion key is input;
requesting, by the text editor, to input an output conversion key in response to a request for loading the stored text; and
converting a normal font corresponding to the output conversion key, followed by restoring the converted text by applying the converted text to the converted font, and outputting the restored text, if the output conversion key is input.

20. The method according to claim 19,
wherein the text is converted by changing in a regular manner, using the input conversion key, positions of intrinsic character images or intrinsic codes of the text within different code areas, and
wherein the font is converted by changing in the same regular manner, using the output conversion key, positions of intrinsic character images or intrinsic codes of glyphs of the font within different font areas.
